(19) United States
(12) Patent Application Publication
(10) Pub. No.: US 2011/0165214 A1
(43) Pub. Date: Jul. 7, 2011

(54) Use of a plastic composition and a product obtained thereby

(75) Inventor: Luigi Mocchia, Trino (IT)

(73) Assignee: POLYGIENE AB, Malmo (SE)

(21) Appl. No.: 12/946,664

(22) Filed: Nov. 15, 2010

Related U.S. Application Data
(63) Continuation-in-part of application No. 10/585,862, filed on Jul. 11, 2006, now abandoned.

(30) Foreign Application Priority Data
Feb. 23, 2004 (SE) 0400409-9

(51) Int. Cl. A01N 59/16; A01N 25/26; A01N 55/02; A01P 1/00

(52) U.S. Cl. 424/421; 424/618; 514/184

(57) ABSTRACT

Disclosed is a method of inactivating or destroying viruses on a product or article surface coming into contact with a mammal, including man, said method comprising providing said surface with a viricidal activity obtained by incorporating into said product or article, or by coating said product or article with an effective amount of at least one viricide or a composition comprising at least one viricide, wherein said viricide comprises (i) elemental silver deposited on glass particles having a particle size of 5-50 μm, said elemental silver being deposited in an amount of 0.5-5% by weight calculated on said glass particles, or (ii) a silver salt deposited on metal oxide particles having a particle size of 0.1-2 μm, said silver salt being deposited in a weight ratio silver salt to metal oxide of between 10:90 and 70:30, and wherein said viricide is present in an amount corresponding to between 0.001 and 1 g elemental silver/kg of said product or article.

### CROSS-REFERENCE TO RELATED APPLICATIONS

This application is a Continuation-In-Part (CIP) of U.S. Ser. No. 10/585,862 filed Jul. 11, 2006, which is the 35 U.S.C. 371 filing of PCT/SE2005/000089, filed Jan. 27, 2005, claiming priority of Swedish Patent Application 0400409-9, filed Feb. 23, 2004

### BACKGROUND OF THE INVENTION

1. Field of the Invention

The present invention refers to a method of inactivating or destroying viruses on product or article surfaces, such as a product or article surface coming into contact with a mammal, including man. Said method comprising incorporating into said product or article, or coating of said product or article with an effective amount of at least one viricide or a composition comprising at least one viricide, wherein said viricide comprises elemental silver deposited on glass particles, or a silver salt deposited on metal oxide particles.

2. Description of the Related Art

Silver ions and silver compounds are known to show a toxic effect on some bacteria, algae and fungi. Hippocrates wrote that silver had beneficial healing and anti-disease properties, and the Phoenicians used to store water, wine, and vinegar in silver bottles to prevent spoiling. In the early 1900s people would put silver coins in milk bottles to prolong the milk's freshness. Silver compounds, such as silver nitrate solutions, were used to prevent infection in World War I before the advent of antibiotics. The use of silver nitrate solutions was later largely replaced by silver sulfadiazine cream (SSD cream), which became the standard care for antibacterial treatment of serious burns until the late 1990s.

Silver is, furthermore, widely used in topical gels and impregnated into bandages because of its wide-spectrum antibacterial activity. The antibacterial properties of silver stem from the chemical properties of its ionized form, Ag⁺. This ion forms strong molecular bonds with other substances used by bacteria to respire, such as molecules containing sulfur, nitrogen, and oxygen. When the Ag⁺ ion forms a complex with these molecules, they are rendered unusable by the bacteria, depriving them of necessary compounds and eventually leading to the bacteria's death. The exact process of silver's antibacterial effect is still not entirely understood, although theories exist. One of these is the oligodynamic effect, which explains the effect on bacteria but does not explain any antiviral effects. Various silver compounds, devices to make homeopathic solutions and colloidal silver suspensions are sold as homeopathic remedies for numerous conditions.

Silver as antimicrobial agent is, furthermore, known from the patent literature, such as
Chinese patent application CN 101187079, to Yanping et al, disclosing antibacterial and anti-ultraviolet compounds comprising, among other compounds, nano-scaled silver nitrate.
Published International patent application WO 2008/153239, to Jeong, teaching anti-microbial and anti-fungus wet tissues comprising metallic nano particles of one or more metals selected from the group consisting of gold, platinum, silver, selenium, zinc, copper and tungsten.
US patent application publication US 2007/0026087, to Koji et al, disclosing antiviral agents comprising complex silver ion carriers of formula AgₐA_{b}M2_{c}(PO₄)_{d}.nH₂O wherein A is alkali or alkaline earth metal and M2 is zirconium or titanium, such as silver zirconium phosphate, silver containing silica gel or silver containing zeolite Y.
U.S. Pat. No. 5,736,591, to Dunn, teaching a latex composition having resistance towards bacterial growth, said resistance being obtained by addition of ions of copper, silver or gold.

### SUMMARY OF THE INVENTION

The objective of the present invention is to provide a method of in vitro inactivating or destroying viruses on for instance a product or article surface coming into contact with a mammal, including man. The method of the present invention comprises providing said surface with a viricidal activity obtained by incorporating into said product or article, or by coating said product or article with an effective but exceptionally low amount of at least one viricide or a composition comprising at least one viricide. A viricide is generally understood as a chemical or herbal compound inactivating or destroying viruses inside or, as according to the present invention, outside the body.

### BRIEF DESCRIPTION OF THE DRAWINGS

FIG. 1 is a graphical representation of the effect of silver sulfate on glass particles against SARS coronavirus according to Example 1;

FIG. 2. is a graphical representation of the effect of elemental silver on glass particles against H5N1 virus according to Example 2;

FIG. 3 is a graphical representation of the effect of silver chloride on titanium dioxide particles against H5N1 virus according to Example 3; and

FIG. 4 is a graphical representation according to Example 4 of silver chloride on titanium dioxide particles applied to cotton/polyester blend cloth against H5N1 virus.

### DETAILED DESCRIPTION OF THE PREFERRED EMBODIMENTS

The viricide of the present invention comprises either (i) elemental silver deposited on glass particles having a particle size of 5-50 μm, such as 5-20 μm or 5-10 μm, said elemental silver being deposited in an amount of 0.5-5% by weight calculated on said glass particles, or (ii) a silver salt, such as silver chloride, silver sulfate, silver nitrate or silver sulfadiazine, deposited on metal oxide particles, such as titanium dioxide particles, preferably of anastas grade, having a particle size of 0.1-2 μm, said silver salt being deposited in a weight ratio silver salt to metal oxide of between 10:90 and 70:30. Said viricide is suitably and preferably present in an amount corresponding to between 0.001 and 1 g, such as between 0.003 and 0.1 g or between 0.005 and 0.08 g, elemental silver/kg of said product or article.

According to embodiments of the present invention, the viricidal activity is obtained by spray coating said product or article with a said viricide or a composition comprising said viricide, by immersion impregnation of said product or article with a said viricide or a composition comprising said viricide, by incorporating a said viricide or a composition comprising said viricide into a raw material from which raw material said product or article wholly or partly is produced, or by applying a surface coating, such as a decorative or protective paint or varnish, comprising a said viricide or a composition comprising a said viricide onto at least parts of said product or article. The present invention is not limited to said methods of obtaining a product or article surface having viricidal activity as other methods of course also are possible to employ.

Embodiments of the product or article having a surface exhibiting viricidal activity obtained by a viricide according to the present invention include, but are not limited to, textile products and articles, and leather products and articles, wherein said viricide comprises a silver salt, such as silver chloride, deposited on for instance titanium dioxide in amounts corresponding to between 1 and 100 mg, such as between 1 and 60 mg, between 1 and 50 mg, or between 1 and 20 mg, elemental silver/kg of said textile or said leather product or article, and products and articles, made from for instance thermosetting or thermoplastic resins, wherein said viricide comprises elemental silver deposited on glass particles. Products and articles made from thermosetting and thermoplastic resins can suitably be exemplified by molding compounds comprising urea-formaldehyde resins, melamine-formaldehyde resins, melamine-urea-formaldehyde resins, polyester resins, such as poly(alkylene)phthalates which includes poly(alkylene o-phthalate)s, poly(alkylene isophthalate)s and poly(alkylene terephthalate)s such as poly(ethylene isophthalate)s, poly(butylene isophthalate)s, poly(propylene isophthalate)s, poly(cyclohexyldimethylene isophthalate)s, poly(ethylene terephthalate)s, poly(butylene terephthalate)s, poly(propylene terephthalate)s, poly(cyclohexyldimethylene terephthalate) and modified species thereof, polyolefins, such as polyethylenes, polypropylenes, polybutylenes, polystyrenes and poly(vinyl)chlorides, and polyacrylates. Said product or article is most suitably an article of clothing, a kitchenware, a tableware, a household article, a sanitary article, a health care article, an ornamental article or a thermosetting decorative laminate, such as flooring laminates and table/desk tops.

The viricide according to the present invention, despite not being nano-scaled and not comprising nano-scaled components, exhibits very good and highly unexpected viricidal activity even against for instance corona viruses, such as SARS coronavirus, a very aggressive virus known to have caused the death of many people, and avian influenza virus H5N1. Of course, the present invention may be extremely important in fighting SARS coronavirus, but also other viruses, such as influenza A, B and C viruses of for instance subtype H1N1, H2N2, H3N2, H5N1, H7N7, H1N2, H9N2, H7N2, H7N3 and H10N7.

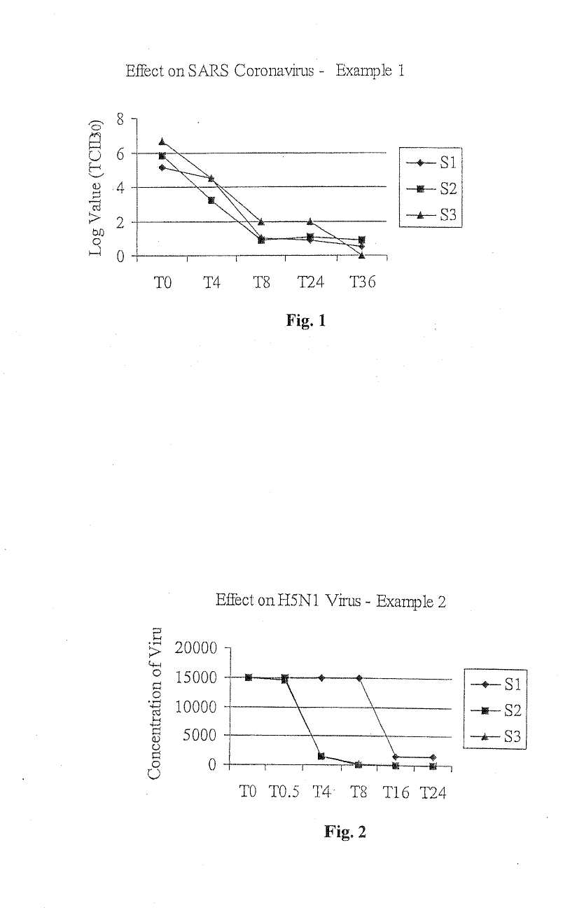

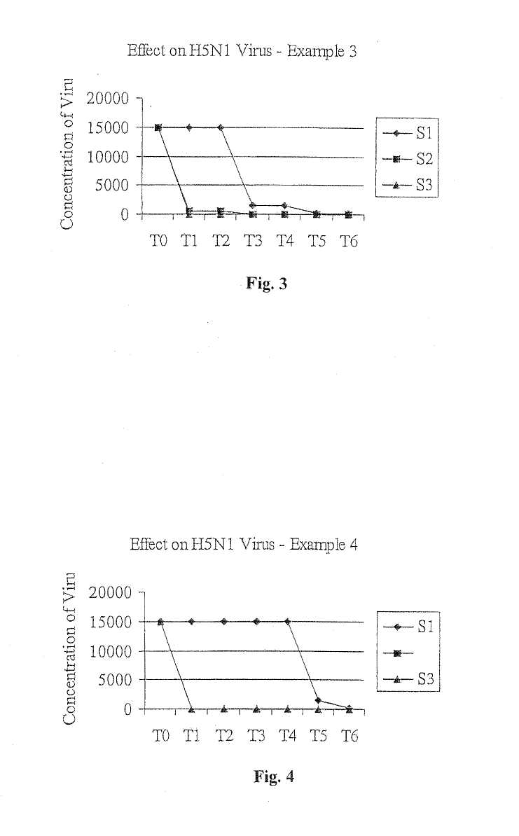

The present invention is explained further in connection with embodiment Examples 1-4 below and enclosed FIGS. 1-4 showing the effect of viricides according to the present invention when used in thermosetting and textile products and articles. All tests were carried out by the Military Academy of Medical Science, Beijing, China.

### EXAMPLE 1

Test sample wells, dimension 1.5×1.5 cm, were molded from a urea-formaldehyde molding compound comprising silver sulfate on glass particles in an amount corresponding to 1.5 ppm (S1), 1 ppm (S2) and 0.25 ppm (S3) elemental silver/kg molded product.

The in vitro viricidal activity of samples S1, S2 and S3 was tested in Vero E6 cell line infected with SARS coronavirus (BJ01) supplied by Beijing Institute of Microbiology and Epidemiology. The cultures of virus strain in Vero E6 and Vero cell line were prepared for the experiment as follows:
100 μl culture (the virus titer expressed as TCID₅₀=LOG 7.0) were daubed onto the surface of each well. The samples were left at the room temperature and calibrated aliquot of suspension was after 0 min, 4 hrs, 8 hrs, 24 hrs and 36 hrs collected from each well to determine survived virus. Each sample was diluted from 10⁻¹ to 10⁻⁷ and inoculated in 4 culture wells and cultured at 37° C. in an atmosphere comprising 5% of CO₂. Cell Pathogenic Effect (CPE) was continually observed and the TCID₅₀ was calculated.

Living SARS coronavirus could in samples S1 and S2 not be detected after 36 hrs (<1% still living SARS coronavirus) and living SARS coronavirus in sample S3 could already after 24 hrs not be detected. The calculated TCID₅₀ values after 0 min (T0), 4 hrs (T4), 8 hrs (T8), 24 hrs (T24) and 36 hrs (T36) for S1, S2 and S3 are given in enclosed Graph 1. The virus values are expressed as log values of TCID₅₀.

### EXAMPLE 2

Pieces, 1.5 cm², were cut from thermosetting laminates comprising elemental silver on glass particles in an amount corresponding to 1 ppm (S2) and 0.25 ppm (S3) elemental silver/kg laminate. A similar control sample were cut from a thermosetting laminate without any silver or other viricide.

The in vitro viricidal activity was tested in MDCK cell line infected with avian influenza virus H5N1. The H5N1 influenza virus (H5N1-CoV) VN-PR8-CDC/RG was supplied by the World Health Organization (WHO). The cultures of virus strain were prepared for the experiment as follows.
H5N1 virus was distributed over the surfaces of said laminate pieces. The samples were exposed to the virus media for 0 min, 30 min, 4 hrs, 8 hrs, 16 hrs and 24 hrs. The Cell Pathogenic Effect (CPE) was continually observed and the TCID₅₀ was calculated. Virus samples were taken from the laminate surfaces and diluted from 10⁻¹ to 10⁻⁶. 150 μl of each diluted sample (the virus titer expressed as TCID₅₀=LOG 7.0) was inoculated into a test sample well of a micro plate (Costar) prepared with MDCK cell line and incubated at 37° C. in an atmosphere comprising 5% of CO₂ for 24 hrs and 48 hrs. The cells were precipitated with phosphate buffered saline (PBS) and the supernatant solution was removed from the well. The amount of surviving viruses was detected by ELISA (the method is the same as the one supplied by WHO). Each test was repeated three times.

Living H5N1 virus could in S2 and S3 not be detected after 16 hrs (<1% of still living H5N1 virus), whereas the TCID₅₀ of S1 had decreased by 90% during the same time period. The calculated TCID₅₀ values after 0 min (T0), 0.5 hrs (T0.5), 4 hrs (T4), 8 hrs (T8), 16 hrs (T16) and 24 hrs (T24) are given in enclosed Graph 2.

### EXAMPLE 3

Pieces, 1.5 cm², were cut from polyester textile cloth comprising silver chloride on titanium dioxide particles in an amount corresponding to 100 ppm (S2) and 50 ppm (S3) elemental silver/kg textile cloth. Said polyester cloth was provided with said viricide by impregnation using an aqueous suspension comprising 10% by weight of particles consisting of 83% by weight of titanium dioxide and 17% by weight of silver chloride. A similar control sample were cut from a polyester textile cloth without any silver or other viricide.

The in vitro viricidal activity was tested in MDCK cell line infected with avian influenza virus H5N1. The H5N1 influenza virus (H5N1-CoV) VN-PR8-CDC/RG was supplied by the World Health Organization (WHO). The cultures of virus strain were prepared for the experiment as follows.
The textile pieces were placed in wells and H5N1 virus was added to said textile pieces. The samples were exposed to the virus media for 0 min, 30 min, 4 hrs, 8 hrs, 16 hrs and 24 hrs. The Cell Pathogenic Effect (CPE) was continually observed and the TCID₅₀ was calculated. Virus samples were taken from the textile pieces and diluted to 10⁻¹, 10⁻², 10⁻³, 10⁻⁴, 10⁻⁵ and 10⁻⁶. 150 μl of each diluted sample (the virus titer expressed as TCID₅₀=LOG 7.0) was inoculated into a test sample well of a micro plate (Costar) prepared with MDCK cell line and incubated at 37° C. in an atmosphere comprising 5% of CO₂ for 24 hrs and 48 hrs. The cells were precipitated with phosphate buffered saline (PBS) and the supernatant solution was removed from the well. The amount of surviving viruses was detected by ELISA (the method is the same as the one supplied by WHO). Each test was repeated three times.

The H5N1 virus is on samples treated with a viricide, according to the present invention, killed completely within 30 minutes or less.

The calculated TCID₅₀ values after 0 hr (T0), 5 min (T1), 60 min (T2), 4 hrs (T3), 8 hrs (T4), 16 hrs (T5) and 24 hrs (T6) are given in the enclosed Graph 3.

### EXAMPLE 4

Example 3 was repeated with the difference that the polyester textile cloth was replaced by a cotton/polyester blend textile cloth and that only samples S1 (untreated) and S3 (treated with 0.25 ppm silver) were tested.

The calculated TCID₅₀ values after 0 hr (T0), 30 min (T1), 60 min (T2), 4 hrs (T3), 8 hrs (T4), 16 hrs (T5) and 24 hrs (T6) are given in the enclosed Graph 4.

I claim:

1. A method of inactivating or destroying viruses on a product or article surface coming into contact with a mammal, including man, said method comprising providing said surface with a viricidal activity obtained by incorporating into said product or article, or by coating said product or article with an effective amount of at least one viricide or a composition comprising at least one viricide, wherein said viricide comprises
i) elemental silver deposited on glass particles having a particle size of 5-50 μm, said elemental silver being deposited in an amount of 0.5-5% by weight calculated on said glass particles, or
ii) a silver salt deposited on metal oxide particles having a particle size of 0.1-2 μm, said silver salt being deposited in a weight ratio silver salt to metal oxide of between 10:90 and 70:30,
and wherein said viricide is present in an amount corresponding to between 0.001 and 1 g elemental silver/kg of said product or article.

1. A method according to claim 1, wherein said viricide is present an amount corresponding to between 0.003 and 0.1 g elemental silver/kg of said product or article.

2. A method according to claim 1, wherein said viricide is present in an amount corresponding to between 0.005 and 0.08 g elemental silver/kg of said product or article.

3. A method according to claim 1, wherein said metal oxide is titanium oxide.

4. A method according claim 4, wherein said titanium dioxide is an anastas grade.

5. A method according to claim 1, wherein said silver salt is silver chloride, silver sulfate, silver nitrate or silver sulfadiazine.

6. A method according to claim 1, wherein said viricidal activity is obtained by spray coating said product or article with a said viricide or a composition comprising said viricide.

7. A method according to claim 1, wherein said viricidal activity is obtained by immersion impregnation of said product or article with a said viricide or a composition comprising said viricide.

8. A method according to claim 1, wherein said viricidal activity is obtained by incorporating a said viricide or a composition comprising a said viricide into a raw material from which raw material said product or article wholly or partly is produced.

9. A method according to claim 1, wherein said viricidal activity is obtained by applying a surface coating comprising a said viricide or a composition comprising a said viricide onto at least parts of said product or article.

10. A method according to claim 9, wherein said surface coating is a decorative or protective paint or varnish.

11. A method according claim 1, wherein said product or article wholly or partly is made from textile and said viricide comprises silver chloride deposited on titanium dioxide.

12. A method according claim 1, wherein said product or article wholly or partly is made of leather and said viricide comprises silver chloride deposited on titanium dioxide.

13. A method according claim 12 or 13, wherein said viricide is present in an amount corresponding to between 1 and 100 mg elemental silver/kg of said textile or said leather.

14. A method according claim 12 or 13, wherein said viricide is present in an amount corresponding to between 1 and 60 mg elemental silver/kg of said textile or said leather.

15. A method according claim 1, wherein said product or article wholly or partly is made from a thermosetting or thermoplastic resin and said viricide comprises elemental silver deposited on glass particles.

16. A method according claim 16, wherein said thermosetting resin is a urea-formaldehyde resin, a melamine-formaldehyde resin, melamine-urea-formaldehyde resin or a polyester resin.

17. A method according claim 16, wherein said thermoplastic resin is a polyolefin, a polyester, a polystyrene, a poly(vinyl)chloride or a polyacrylate.

18. A method according claim 18, wherein said polyolefin is polyethylene, polypropylene or polybutylene.

19. A method according claim 16, wherein said thermoplastic resin is a poly(alkylene)phthalate.

20. A method according claim 20, wherein said poly(alkylenephthalate) is a poly(alkylene o-phthalate), a poly(alkylene isophthalate) or a poly(alkylene terephthalate)

21. A method according claim 20, wherein said poly(alkylenephthalate) is poly(ethylene isophthalate), a poly(butylene isophthalate), a poly(propylene isophthalate), a poly(cyclohexyldimethylene isophthalate), a poly(ethylene terephthalate), a poly(butylene terephthalate), a poly(propylene terephthalate) or a poly(cyclohexyldimethylene terephthalate).

22. A method according claim 1, wherein said product or article is an article of clothing, a kitchenware, a tableware, a household article, a sanitary article, a health care article, an ornamental article or a thermosetting decorative laminate.

23. A method according claim 1, wherein said viricide inactivates or destroys a SARS coronavirus.

24. A method according claim 1, wherein said viricide inactivates or destroys an influenza A, B or C virus.

25. A method according claim 25, wherein said influenza virus is of subtype H5N1.
